(19) United States
(12) Patent Application Publication
(10) Pub. No.: US 2017/0220326 A1
(43) Pub. Date: Aug. 3, 2017

(54) iNecklace & iAlphabet & iUniverse

(71) Applicants: Mei W. Yan, San Jose, CA (US); Tony Ly, San Jose, CA (US); Atti Liu, San Jose, CA (US)

(72) Inventors: Mei W. Yan, San Jose, CA (US); Tony Ly, San Jose, CA (US); Atti Liu, San Jose, CA (US)

(21) Appl. No.: 14/999,721

(22) Filed: Jan. 30, 2016

(51) Int. Cl. G06F 9/44; G06F 7/498; A44C 15/00

(52) U.S. Cl. CPC G06F 8/30; A44C 15/005; G06F 7/4983; G06F 7/4981

(57) ABSTRACT

A method for iNecklace-iAlphabet-iUniverse comprises receiving a request for intuitive structures from the environment, constructing the iAlphabet, computing the identity, performing algebraic, categorical, and homotopy type constructions, performing constructions with measures, recalling relevant instances with reconstructions, identifying the analytic device, enabling composability to construct iUniverse.

### BACKGROUND

One of classic problems in computing is constructing abstract structures such as groups, rings, modules, fields etc. This invention proposes a method to construct a structure of iNecklace which composes iAlphabet and iUniverse.

### SUMMARY

In general, in one aspect, the invention relates to a method for iNecklace-iAlphabet-iUniverse comprises receiving a request for intuitive structures from the environment, constructing the iAlphabet, computing the identity, performing algebraic, categorical, and homotopy type constructions, performing constructions with measures, recalling relevant instances with reconstructions, identifying the analytic device, enabling composability to construct iUniverse.

Other aspects of the invention will be apparent from the following description and the appended claims.

### BRIEF DESCRIPTION OF DRAWINGS

FIG. 1, show flowcharts in accordance with one embodiment of the invention.

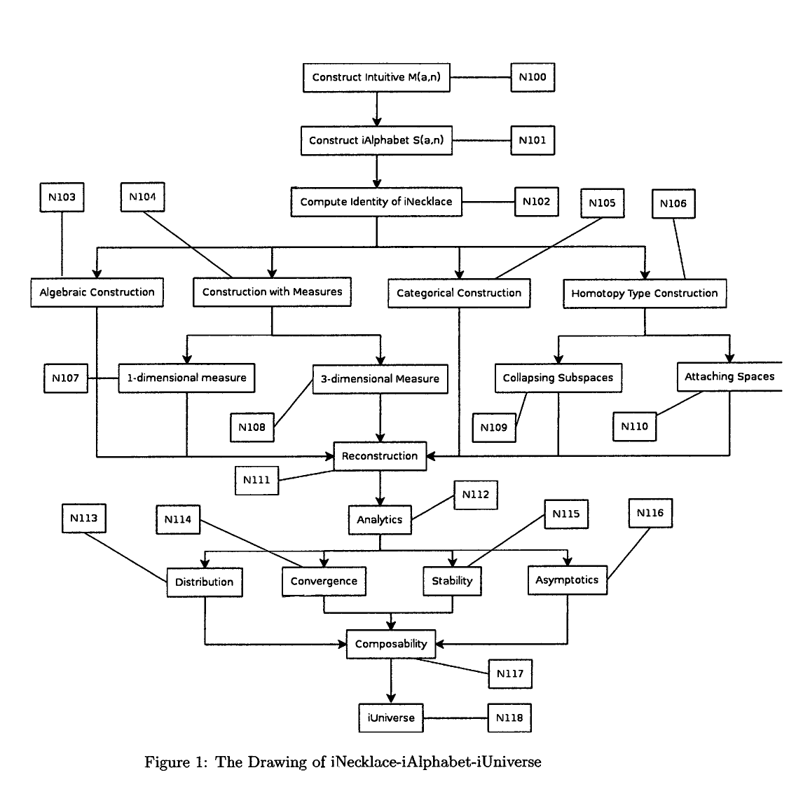

### DETAILED DESCRIPTION

(1) Exemplary embodiments of the invention will be described with reference to the accompanying drawings. Like items in the drawings are shown with the same reference numbers.

(2) In an embodiment of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

(3) In general, embodiments of the invention relate to a method and apparatus for for computing. More specifically, embodiments of the invention enable iNecklace-iAlphabet-iUniverse including information and structures proceeded through a series of steps. The structures specify and characterize iAlphabets and iUniverses by producing the collection of all algebras, geometry, topologies, categories, homotopy types, toposes, and measures.

(4) In one embodiment of the invention, initially, a request starts to construct intuitive structures. Take a set of α colors as an input, the intuitive structure is obtained by placing n colored beads around a circle. The result of necklace represents a structure with n circularly connected beads of up to α different colors. In one embodiment of the invention, a determination is made about the intuition to construct intuitive structure with discrete sums M(a,n) (N100).

(5) In one embodiment of the invention, a determination is made about to construct iAlphabet with the above intuitive structures. Take a set A as an alphabet. Set the characters to be the elements of A. Construct a word by a finite juxtaposition of characters of the alphabet A, which is an element of the free monoid generated by A. Take two words u and v as input, w and w′ are conjugate when w=uv and w′=vu. The empty word is the identity in the monoid of words. The conjugate relation is an equivalence relation. An equivalence class of words forms a necklace. Construct iAlphabet as S(a;n) (N101), which is the number of aperiodic words of length n out of an alphabet A containing a letters, and by M(a,n) the number of necklaces of length n.

(6) In one embodiment of the invention, a determination is made about to construct the identity (N102). Construct an isomorphism between the necklace ring and the ring of Witt vectors. Witt vectors is viewed as numbers which have several representations by digits. Construct the real field, when one uses the binary symbols to represent real numbers, a rational number has two distinct binary representations. The construction also satisfies the explicit digital representation of other fields.

(7) In one embodiment of the invention, a determination is made to perform algebraic construction (N103). Taking a commutative ring with identity A as an input, one defines a commutative ring over A on all infinite vectors a=(a,a₂, . . . ); b=(b₁,b₂, . . . ), aᵢ,bⱼεA. Addition is performed componentwise. Multiplication c=a*b is performed as the arithmetic convolution cₙ=Σ_{(i,j)=n}(i,j)aᵢbⱼ. The identity of the ring structure is the vector (1,0,0, . . . ). The necklace ring M(A) over A constructed above has the underlying additive Abelian group.

(8) In one embodiment of the invention, a determination is made to measure the iNecklace (N104). The measure can be constructed in 1-dimension and 3-dimension respectively.

(9) In one embodiment of the invention, a determination is made to measure the iNecklace in 1-dimension (N107). Take the Antoine's necklace, which is a topological embedding of the Cantor set in 3-dimensional Euclidean space, whose complement is not simply connected as an input, the Antoine's necklace is constructed iteratively. The iteration 0 is started with a solid torus A⁰. The iteration 1 is to construct a necklace A¹ of a smaller and linked tori that lie inside A⁰. Each torus composing A¹ can be replaced with another smaller necklace as A⁰. This yields A². This construction continues the iterations with countably infinite number of times to create an Aⁿ for all n. Since the solid tori are chosen to become arbitrarily small when the number of iterations increases, the connected components of A are single points so A is closed and dense in itself. A is also totally disconnected with the cardinality of the continuum. Hence, A is homeomorphic to the Cantor set.

(10) In one embodiment of the invention, a determination is made to measure the iNecklace in 3-dimension (N108). The above construction of Antoine's necklace yields a Cantor of 1-dimensional Hausdorff measure in [symbol] ³. One can adapt the construction to construct a larger Cantor set, Antoine's necklace with positive 3-dimensional Hausdorff measure or Lebesgue measure. Given a torus, one can find four linked tori of arbitrarily large relative measure inside the torus. One can proceed the construction by fixing a sequence rₙε(0,1) such that

$${\prod }_{n = 1}^{∞} {r}_{n} = \frac{1}{2} .$$

One can start with a torus T₀⊂ [symbol] ³ of unit volume and replace T₀ by the union T₁ of four linked tori T_{1,1} . . . , T_{1,4} whose union has measure r₁. Then replace each T_{1,i} by four linked tori T_{1,i,j} contained in T_{1,i} whose union has measure r₁r₂; let T₂ be the union of the 16 tori. When the construction continues inductively, the intersection ∩ₙTₙ is an Antoine necklace of measure 1/2. One needs to ensure that the diameters of the tori that make up Tₙ go to zero as n→∞ so that the resulting set is totally disconnected.

(11) In one embodiment of the invention, a determination is made to perform the categorical construction (N105). Taking a functor [symbol] :sSet→sCat from the category of simplicial sets to the category of simplicially enriched categories, one constructs [symbol] :sSet→sCat to be the left Kan extension of the cosimplicial object [symbol] Δ•:Δ→sCat along the Yoneda embedding. The objects of [symbol] X are the vertices of X. Every edge of [symbol] X (x,y) corresponds to a necklace Δⁿ^{₁} [symbol] . . . [symbol] Δⁿ^{ᵣ}→X in X, where Δⁿ [symbol] Δ^{k} means that the final vertex of the n-simplex is identified with the initial vertex of the k-simplex. A necklace is constructed with a sequence of beads Δⁿ^{ᵢ} that are strung together along the joins which is defined to be the union of the initial and final vertices of each bead. When the initial and terminal vertices are specified as its basepoints, a necklace can be constructed as an object in sSet_{*,*}. From a necklace to a simplicial set X with basepoints x and y, a map in sSet_{*,*} determines a 1-simplex in the hom-space [symbol] X(x,y). By tracking additional vertex data, necklaces characterize the higher dimensional simplices of the hom-spaces [symbol] (x,y).

(12) In one embodiment of the invention, a determination is made to perform the homotopy type construction (N106). The homotopy types can be constructed by collapsing subspaces and attaching spaces.

(13) In one embodiment of the invention, a determination is made to perform the homotopy type construction by collapsing subspaces (N109). Taking X to be the union of a torus with n meridional disks as an input, one obtains a CW structure on X by choosing a longitudinal circle in the torus, intersecting each of the meridional disks in one point. These intersection points are the 0 cells. The 1 cells are the rest of the longitudinal circle and the boundary circles of the meridional disks. The 2 cells are the remaining regions of the torus and the interiors of the meridional disks. Collapsing each meridional disk to a point creates a homotopy equivalent space Y consisting of n 2-spheres, each tangent to its two neighbors. This is a necklace with n beads. A strand of n beads with a string joining its two ends, collapses to Y by collapsing the string to a point. The collapse is a homotopy equivalence.

(14) In one embodiment of the invention, a determination is made to perform the homotopy type construction by collapsing subspaces (N110). The necklace can be constructed from a circle S¹ by attaching n 2-spheres S² along arcs. The necklace N(n, S¹,aᵢ) is homotopy equivalent to the space constructed by attaching n 2-spheres S² to a circle S¹ at points aᵢ. The drawing of the construction is shown in figure ??.

Inductive Necklace (n:nat):=

|strand:Circle→Necklace

|bead:forall(k:nat), k<n→Sphere2→Necklace

|attach:forall(k:nat)(p:k<n), strand base=bead k p base2.

(15) In one embodiment of the invention, a determination is made to perform the reconstruction (N111). Taking partial information as an input, the reconstruction of a necklace needs n beads, each of which is either black or white. A k-configuration in the necklace is a subset of k positions in the necklace. Two configurations are isomorphic when one is obtained from the other by a rotation of the necklace. At stage k of the reconstruction for each k-configuration, the partial information at the stage is a count of the number of k-configurations that are isomorphic to it and that contain only black beads. Given n, with finite number of stages in the worst case, one can reconstruct the precise pattern of black and white beads in the original necklace.

(16) In one embodiment of the invention, a determination is made to construct the analytic device (N112). There are distribution, convergence, stability, and asymptotic evaluations.

(17) In one embodiment of the invention, a determination is made to construct the distribution analytics (N113). Applying the analysis to the the dinner table problem, the nth and 1st distinguishable things are nearest neighbors. Analysis proves that the limiting result in the case of large n. If n goes to infinity, then the number of ways to rearrange the n objects while preserving k nearest neighbors falls on a Poisson distribution, whose mean satisfies k=2.

(18) In one embodiment of the invention, a determination is made to construct the convergence analytics (N114). Take a very large necklace with length n and n+1 as an input. When n→∞, the limit of M(n+1,a)/M(n,a) is bounded. The limit for n→∞ of both bounds is a, so the ratio tends to a for n→∞.

(19) In one embodiment of the invention, a determination is made to construct the convergence analytics (N115). Take M(αβ,n) expressed as a quadratic polynomial in M(α,i) and M(β,j) as an input, one generalizes it to more variables. M(a^{r},n) can be constructed linearly and integrally in terms of M(a,i).

(20) In one embodiment of the invention, a determination is made to construct the asymptotics analytics (N116). Take W to be a finite word on a two symbol alphabet {0, 1} as an input. If it is the last item in the list of all its cyclic permutation (ordered lexicographically), then W is maximal. The number w(n) of maximal words of length n can be constructed with the aid of Eulers' totient function. The asymptotics of w(n) is lim(1/n)log w(n)=h for some positive value h and h=1. That is because

$$w ( n ) = \frac{1}{n} {\sum }_{d \vert n} φ ( d ) {2}^{n / d} \geq \frac{1}{n} {2}^{n}$$

by just considering the first summand, and

$$w ( n ) = \frac{1}{n} {\sum }_{d \vert n} φ ( d ) {2}^{n / d} \leq {n2}^{n}$$

by upper-bounding the number of summands to be n each at most n2ⁿ.

(21) In one embodiment of the invention, a determination is made to construct composability (N117). A necklace in the nerve of a category is uniquely constructed by its spine and the set of joins. A necklace is constructed as a sequence of composable non-identity morphisms that each contained in one set of parentheses, which indicates such morphisms are grouped together to form a bead.

(22) In one embodiment of the invention, a determination is made to construct iUniverse (N118). The structures specify and characterize iAlphabets and iUniverses by producing the collection of all algebras, geometry, topologies, categories, homotopy types, toposes, and measures.

### REFERENCE

Antoine's Necklace. In Wikipedia. Retrieved Dec. 31, 2015, from
https://en.wikipedia.org/wiki/Antoine%27s_necklace

Lyndon word. In Wikipedia. Retrieved Dec. 31, 2015, from
https://en.wikipedia.org/wiki/Lyndon_word

Metropolis, N.; Rota, Gian-Carlo (1983). Witt vectors and the algebra of necklaces.
Advances in Mathematics 50 (2):95-125

Necklace. In Wikipedia. Retrieved Dec. 31, 2015, from
https://en.wikipedia.org/wiki/Necklace_(combinatorics)

What is claimed is:

1. A method of iNecklace-iAlphabet-iUniverse for computing comprising:
receiving a request to construct intuitive structures;
constructing iAlphabet with the above intuitive structures;
constructing the identity;
performing algebraic construction;
performing constructions with measure (1-dimension and 3-dimension);
performing categorical construction;
performing homotopy type construction (Collapsing and Attaching);
performing reconstruction;
constructing analytic device;
constructing composability;
constructing iUniverse.

2. The method of claim 1, further comprising:
processing the collected data on the management system to obtain processed data; and
displaying the processed data on the graphical user interface operatively connected to the management system

3. The method of claim 1, wherein the probe command comprise source code.

4. The method of claim 3, wherein determining the probe to enable comprise:
generating object code using the source code;
forwarding the object code to the tracing framework; and
analyzing the object code by the tracing framework to determine the probe to enable.

5. The method of claim 1, wherein constructing intuitive structures comprise:
Constructing a set of a colors
Constructing a cicle
Placing n colored beads around the circle
Determining if n circularly connected beads of up to alpha different colors
Constructing M(a,n)

6. The method of claim 1, wherein constructing iAlphabet comprise:
Constructing an alphabet of a set A
Construct characters from elements of A
Construct words by finite juxtaposition of characters of A
Placing words from A
Conjugate relation
Construct the necklace

7. The method of claim 1, wherein algebraic construction comprise:
Compute the identity
Construct infinite vector a=(a₁,a₂ . . . ),b=(b₁,b₂, . . . ) where the elements of a and b belong to the identity
Perform addition componentwise
Perform multiplication as arithmetic convolution
Construct the identity as (1,0,0, . . . )
Construct the necklace ring

8. The method of claim 1, wherein categorical construction comprise:
Compute the identity
Construct infinite vector a=(aₗ,a₂, . . . ),b=(b₁, b₂, . . . ) where the elements of a and b belong to the identity
Define the functor C as the left Kan extension of the cosimplicial object along Yoneda embedding
Yield the edges of the CX(x,y)
Construct the necklace

9. The method of claim 1, wherein Collapsing construction comprise:
Constructing the union of a torus with n meridional disks
Choosing a longitudinal circle in the torus
Intersect the kth meridional disk in one point
Collapse the kth meridional disk to a point
Construct the necklace

10. The method of claim 1, wherein Attaching construction comprise:
Constructing a natural number n and a circle
Constructing a strand
Constructing the kth 2-sphere as a bead
Attaching the kth 2-sphere along arcs
Construct the necklace

11. The method of claim 1, wherein Attaching construction comprise:
Constructing a natural number n and a circle
Constructing a strand
Constructing the kth 2-sphere as a bead
Attaching the kth 2-sphere along arcs
Construct the necklace

12. The method of claim 1, wherein 1-dimensional measure construction comprise:
Construct a solid torus A⁰
Constructing a necklace A^{k} of smaller and a linked tori in A⁰
Replacing the torus composing A^{k} with another smaller necklace A^{k+1} as A⁰
Obtaining the Cantor set

13. The method of claim 1, wherein 3-dimensional measure construction comprise:
Construct a torus T₀ of unit volume
Construct four linked tori T_{1,1}, . . . ,T_{1,4} whose union has measure r₁
Replacing T₀ by the union of T₁ of the above four linked tori
Construct four linked tori T_{1,1, . . . ,1,4} whose union has measure r₁r₂
Construct the union of 16 tori as T₂
Inductively constructing the intersection ∩ₙTₙ
Obtaining the necklace with 3D measure

14. The method of claim 1, wherein analytic device construction comprise:
Constructing the distribution with limit to derive the Poisson distribution
Constructing the convergence with the bounded limit when n→∞
Constructing the structure preserving operations for products and exponents
Constructing the limit upper-bounding of the asymptotics of w(n)

15. The method of claim 1, wherein composability construction comprise:
Constructing the nerve by spine and joins
Constructing a sequence of non-identity morphisms
Grouping the morphisms together
Forming a bead

16. The method of claim 1, wherein iUniverse construction comprise:
Performing the above algebraic construction
Performing the above categorical construction
Performing the above homotopy type construction
Performing the above constructions with measures
Producing the collection of all algebras, geometry, topologies, categories, homotopy types, toposes and measures
Characterizing the iUniverse
